(19) United States
(12) Patent Application Publication
(10) Pub. No.: US 2022/0051303 A1
(43) Pub. Date: Feb. 17, 2022

(54) COMMODITY DATA PROCESSING DEVICE AND CONTROL METHOD

(71) Applicant: TOSHIBA TEC KABUSHIKI KAISHA, Tokyo (JP)

(72) Inventor: Xiaozhou Wang, Tagata Shizuoka (JP)

(21) Appl. No.: 17/509,160

(22) Filed: Oct. 25, 2021

Related U.S. Application Data
(63) Continuation of application No. 16/689,247, filed on Nov. 20, 2019.

(30) Foreign Application Priority Data
Feb. 1, 2019 (JP) 2019-017134

(51) Int. Cl. G06Q 30/02; G06Q 30/06

(52) U.S. Cl. CPC G06Q 30/0281; G06Q 30/0238; G06Q 30/0627; G06Q 30/0641

(57) ABSTRACT

According to one embodiment, a commodity data processing device identifies a purchaser who has visited a store. The commodity data processing device acquires order information on a commodity ordered by the purchaser. The commodity data processing device acquires purchase information related to a commodity purchased by the purchaser at the store. The commodity data processing device provides a service when a condition of the service is satisfied from the order information and the purchase information.

### CROSS-REFERENCE TO RELATED APPLICATIONS

This application is a Continuation of application Ser. No. 16/689,247 filed on Nov. 20, 2019, the entire contents of which are incorporated herein by reference.

This application is based upon and claims the benefit of priority from Japanese Patent Application No. 2019-017134, filed in Feb. 1, 2019, the entire contents of which are incorporated herein by reference.

### FIELD

Embodiments described herein relate generally to a commodity data processing device and a control method for causing a computer to function as the commodity data processing device.

### BACKGROUND

In recent years, a so-called net supermarket sales method has been widespread in which a real store such as a supermarket opens a virtual store on the Internet and sells commodities being sold at the real store also at the virtual store. In addition, by managing commodity stock information, sales information, purchaser information, and the like in a real store and a virtual store in an integrated manner, a so-called omni-channel mechanism is also being established in which purchasers can order and purchase commodities without being aware of the real store or virtual store.

### DESCRIPTION OF THE DRAWINGS

FIG. 1 is a schematic diagram showing an overall configuration of a sales system that integrates a real store and a virtual store;

FIG. 2 is a schematic diagram showing a main data structure of ordered commodity data;

FIG. 3 is a block diagram showing a main circuit configuration of an information terminal;

FIG. 4 is a block diagram showing a main circuit configuration of a real store server;

FIG. 5 is a schematic diagram showing an example of a shopping basket memory;

FIG. 6 is a schematic diagram showing a data structure of a collective discount table;

FIG. 7 is a flowchart showing a main information processing procedure executed by a processor of the information terminal according to a terminal program;

FIG. 8 is a flowchart showing a main information processing procedure executed by the processor of the information terminal according to the terminal program;

FIG. 9 is a flowchart showing a main information processing procedure executed by the processor of the information terminal according to the terminal program;

FIG. 10 is a flowchart showing a procedure of login command reception processing executed by a processor of the real store server;

FIG. 11 is a flowchart showing a procedure of the login command reception processing executed by the processor of the real store server;

FIG. 12 is a flowchart showing a procedure of commodity registration command reception processing executed by the processor of the real store server;

FIG. 13 is a flowchart showing a procedure of accounting command reception processing executed by the processor of the real store server;

FIG. 14 is a flowchart showing a procedure of accounting cancellation command reception processing executed by the processor of the real store server;

FIG. 15 is a flowchart showing a procedure of scanner command reception processing executed by the processor of the real store server;

FIG. 16 is a schematic diagram showing an example of a registration screen on which a notification operation is performed;

FIG. 17 is a schematic diagram showing an example of a detail screen; and

FIG. 18 is a schematic diagram showing an example of an accounting guidance screen.

### DETAILED DESCRIPTION

Embodiments provide a commodity data processing device capable of providing a service to a purchaser based on the relationship between a commodity ordered at a virtual store and a commodity purchased at a real store (sometimes referred to a brick and mortar store or physical store or store in which a purchaser can stand).

In general, according to one embodiment, a commodity data processing device includes identification means, first acquisition means, second acquisition means, and provision means. The identification means identifies a purchaser who has visited a store. The first acquisition means acquires order information related to the commodity ordered by the purchaser. The second acquisition means acquires purchase information related to the commodity purchased by the purchaser at the store. The provision means provides a service when a condition of the service is satisfied from the order information acquired by the first acquisition means and the purchase information acquired by the second acquisition means.

Hereinafter, an embodiment of a commodity data processing device capable of providing a service to a purchaser based on the relationship between a commodity ordered at a virtual store and a commodity purchased at a real store will be described with reference to drawings. This embodiment is a case where a real store of a method in which a purchaser operates an information terminal attached to a shopping cart to register a purchased commodity opens a virtual store on the Internet. The purchased commodity refers to a commodity purchased by a purchaser at a real store. Then, in this embodiment, when at a real store, a purchaser purchases a second commodity related to a first commodity ordered at a virtual store, a case where a so-called collective discount service for selling the second commodity at a discounted price is provided to the purchaser will be described. Incidentally, this type of collective discount is also referred to as a mix and match discount.

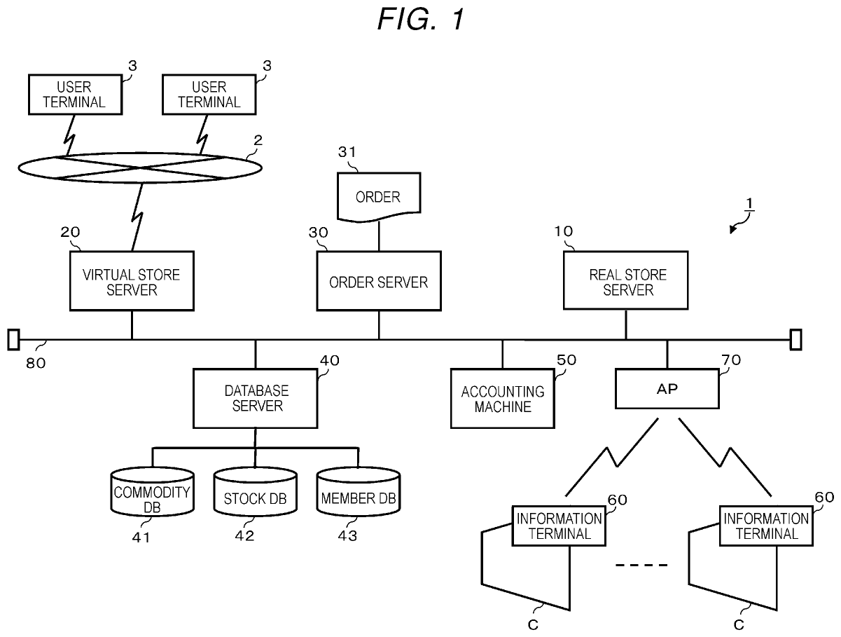

FIG. 1 is a schematic diagram showing an overall configuration of a sales system 1 in which a real store and a virtual store are integrated. The sales system 1 includes a real store server 10, a virtual store server 20, an order server 30, a database server 40, an accounting machine 50, an information terminal 60, and an access point 70. The sales system 1 includes a network 80. The network 80 connects the real store server 10, the virtual store server 20, the order server 30, the database server 40, the accounting machine 50, and the access point 70 in a communicable manner. The network 80 is, for example, a local area network (LAN).

The real store server 10, the accounting machine 50, the information terminal 60, and the access point 70 are provided in a real store. The virtual store server 20 and the order server 30 are devices necessary for realizing a virtual store. The database server 40 is used both at a real store and a virtual store.

The information terminal 60 is a device that enables a purchaser himself/herself who is a customer to input data related to registration of purchased commodities at a real store. The information terminal 60 is provided in a shopping cart C of the real store. Hereinafter, the shopping cart C is simply referred to as a cart C. The cart C is an example of a transport body that transports a purchased commodity of a purchaser who uses the cart C.

The information terminal 60 includes a wireless unit. The information terminal 60 performs wireless communication with the access point 70. The access point 70 relays communication between each device connected to the network 80, that is, the real store server 10, the virtual store server 20, the order server 30, the database server 40, the accounting machine 50, and the information terminal 60. Although only one access point 70 is shown in FIG. 1, two or more access points 70 may be provided depending on the size of the store.

The real store server 10 is a server device for supporting operations from sale of commodities to settlement at a real store. For example, the real store server 10 cooperates with the information terminal 60 to provide support for making the information terminal 60 appear to function as a point of sales (POS) terminal. The real store server 10 cooperates with the accounting machine 50 to support the settlement of one transaction with the purchaser.

The virtual store server 20 is a server device that supports operations from ordering commodities to settlement at a virtual store. The virtual store server 20 is connected to an Internet 2 and opens a Web site for selling commodities, a so-called virtual store, on the Internet 2. The virtual store server 20 receives an order for a commodity from a user terminal 3 that accesses the virtual store via the Internet 2. The user terminal 3 is an electronic device operated by a user who uses a virtual store and corresponds to, for example, a personal computer, a tablet terminal, a smartphone, or the like. When the virtual store server 20 receives an order for a commodity sold at the virtual store via the user terminal 3, the virtual store server 20 transmits data indicating the content of the order to the order server 30.

The price of the commodity ordered at the virtual store is paid by a well-known settlement method such as credit card, electronic money, price exchange, payment at the real store, and the like.

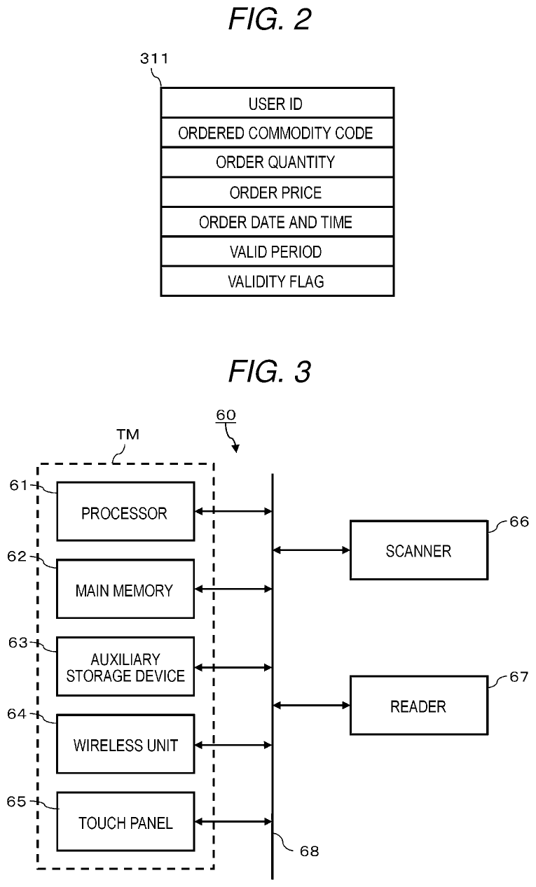

The order server 30 is a server device specialized for managing orders received at a virtual store. The order server 30 generates ordered commodity data 311 (see FIG. 2) based on the data indicating the order details received from the virtual store server 20. The order server 30 includes an order file 31, and the ordered commodity data 311 is registered in the order file 31. The order file 31 is an example of a storage unit that can store a plurality of pieces of ordered commodity data 311. The order file 31 may be provided in a storage device built in the order server 30, or may be provided in a storage device connected to the outside of the order server 30.

FIG. 2 is a schematic diagram showing a main data structure of the ordered commodity data 311. As shown in FIG. 2, the ordered commodity data 311 includes data items such as a user ID, an ordered commodity code, an order quantity, an order price, an order date and time, a valid period, and a validity flag. The user ID is a unique code assigned to each purchaser in order to individually identify the purchaser who has ordered a commodity. A purchaser who uses the virtual store performs member registration in advance on the Web site of the virtual store. For this member registration, a new user ID is issued by a member server (not shown) and notified to the purchaser.

The ordered commodity code is an identification code of a commodity for which an order has been received at the virtual store. A unique commodity identification code is set for each commodity sold in the virtual store or the real store. The commodity identification code is unified regardless of the sales channel of the virtual store or the real store. That is, the commodity identification code of the commodity sold at the virtual store matches the commodity identification code of the same commodity sold at the real store.

The order quantity is the number of commodities for which an order has been accepted at the virtual store. The order price is the price of the commodity at the time when the order is accepted at the virtual store. The order date and time is the date and time when the order is accepted at the virtual store.

The valid period is a period during which the ordered commodity data 311 is valid. When the period set as the valid period elapses from the order date and time, the ordered commodity data 311 becomes invalid. The valid period may be different for each commodity and may be different for each department that classifies the commodity. The valid period may be set in common for all commodities.

The validity flag is 1-bit data for identifying whether or not the ordered commodity data 311 is valid. In the present embodiment, the validity flag when the ordered commodity data 311 is valid is set to “1”, and the validity flag when the ordered commodity data 311 is invalid is set to “0”.

Description will be made by referring back to FIG. 1.

The order server 30 examines the ordered commodity data 311 registered in the order file 31 after the store is closed every business day. The order server 30 calculates the number of days elapsed from the date of the order date to the current date for all the ordered commodity data 311 of which validity flag is “1” indicating validity. Then, the order server 30 changes the validity flag of the ordered commodity data 311 of which elapsed days have reached the valid period to a value “0” indicating invalidity. Further, the order server 30 examines the ordered commodity data 311 registered in the order file 31 every time a preset period, for example, one week elapses. The order server 30 deletes the ordered commodity data 311 of which validity flag is “0” indicating invalidity from the order file 31.

The database server 40 is a server device specialized in the management of databases such as a commodity database 41, a stock database 42, and a member database 43. The commodity database 41 stores data related to sales of various commodities sold in the real store or virtual store in the form of commodity records generated for each commodity. The commodity record includes data items such as a commodity identification code, price, and commodity name. The price is the selling price of the commodity at the present time. The price may be common or different between the real store and the virtual store. For example, although the price stored in the commodity database 41 is one type, the real store server 10 or the virtual store server 20 may change the selling price by increasing or discounting this price.

The stock database 42 stores data related to stocks of various commodities sold in the real store or virtual store in the form of stock records generated for each commodity. The stock record includes data items such as a commodity identification code and the number of inventories. The number of stocks is the total number of commodities being sold at the real store. In the virtual store, it is possible to receive an order for a commodity even if the commodity is not in stock.

The member database 43 stores a member record created for each purchaser who has registered as a member in order to use the virtual store. The member record includes a unique user ID assigned to each purchaser in order to individually identify the purchaser.

The accounting machine 50 is a device that enables a store clerk or a purchaser to account for purchased commodities at the real store. The accounting machine 50 is a well-known self-service POS terminal. The accounting machine 50 may be a known face-to-face POS terminal.

FIG. 3 is a block diagram showing a main circuit configuration of the information terminal 60. The information terminal 60 includes a processor 61, a main memory 62, an auxiliary storage device 63, a wireless unit 64, a touch panel 65, a scanner 66, a reader 67, and a system transmission path 68. The system transmission path 68 includes an address bus, a data bus, a control signal line, and the like. The information terminal 60 connects the processor 61, the main memory 62, the auxiliary storage device 63, the wireless unit 64, the touch panel 65, the scanner 66, and the reader 67 to the system transmission path 68. In the information terminal 60, a computer is configured with the processor 61, the main memory 62, the auxiliary storage device 63, and the system transmission path 68 connecting therebetween. [0027]The processor 61 corresponds to the central part of the computer. The processor 61 controls each unit to implement various functions as the information terminal 60 according to the operating system or application program. The processor 61 is, for example, a central processing unit (CPU). [0028]The main memory 62 corresponds to the main memory part of the computer. The main memory 62 includes a nonvolatile memory area and a volatile memory area. The main memory 62 stores an operating system or application program in the nonvolatile memory area. The application program includes a terminal program described later. The main memory 62 may store data necessary for the processor 61 to execute processing for controlling each unit in the nonvolatile or volatile memory area. The main memory 62 uses the volatile memory area as a work area where data is appropriately rewritten by the processor 61. The nonvolatile memory area is, for example, a read only memory (ROM). The volatile memory area is, for example, a random access memory (RAM).

The auxiliary storage device 63 corresponds to the auxiliary storage portion of the computer. For example, an electric erasable programmable read-only memory (EEPROM), a hard disc drive (HDD), a solid-state drive (SSD), or the like can be the auxiliary storage device 63. The auxiliary storage device 63 stores data used when the processor 61 performs various processing, data created by the processing in the processor 61, and the like. The auxiliary storage device 63 may store application programs including a terminal program to be described later.

The wireless unit 64 performs wireless data communication with the access point 70 according to a wireless communication protocol.

The touch panel 65 is a device that has both an input device and a display device of the information terminal 60. The touch panel 65 detects a touch position with respect to a displayed image and outputs the touch position information to the processor 61.

The scanner 66 reads a code symbol such as a barcode or a two-dimensional data code attached to a commodity. A code symbol representing a commodity identification code of a commodity is attached to the commodity. The scanner 66 outputs the read code symbol data to the processor 61. The scanner 66 may be a type that reads a code symbol by scanning with a laser beam, or may be a type that reads a code symbol from an image captured by an imaging device.

The reader 67 reads the data recorded on a recording medium and outputs the read data to the processor 61. The reader 67 is a magnetic card reader when the recording medium is a magnetic card, and is an IC card reader when the recording medium is a contact IC card. In the case of a recording medium using radio frequency identification (RFID) such as a non-contact IC card or a smartphone, an RFID reader is used as the reader 67.

In the information terminal 60 including the circuit components as described above, the processor 61, the main memory 62, the auxiliary storage device 63, the wireless unit 64, and the touch panel 65 are configured with a tablet terminal TM. The information terminal 60 is configured by electrically connecting the scanner 66 and the reader 67 to the tablet terminal TM.

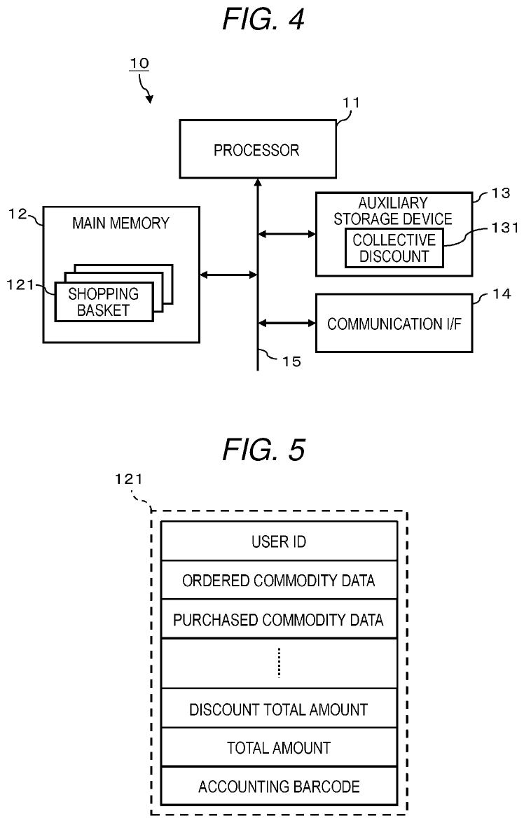

FIG. 4 is a block diagram showing a main circuit configuration of the real store server 10. The real store server 10 includes a processor 11, a main memory 12, an auxiliary storage device 13, a communication interface 14, and a system transmission path 15. The system transmission path 15 includes an address bus, a data bus, a control signal line, and the like. The real store server 10 connects the processor 11, the main memory 12, the auxiliary storage device 13, and the communication interface 14 to the system transmission path 15. In the real store server 10, a computer is configured with the processor 11, the main memory 12, the auxiliary storage device 13, and the system transmission path 15 connecting therebetween.

The processor 11 corresponds to the central part of the above computer. The processor 11 controls each unit to realize various functions as the real store server 10 according to an operating system or application programs. The processor 11 is a CPU, for example.

The main memory 12 corresponds to the main memory portion of the computer. The main memory 12 includes a nonvolatile memory area and a volatile memory area. The main memory 12 stores an operating system or application program in the nonvolatile memory area. The application program includes a control program described later. The main memory 12 may store data necessary for the processor 11 to execute processing for controlling each unit in the nonvolatile or volatile memory area. The main memory 12 uses a volatile memory area as a work area where data is appropriately rewritten by the processor 11. The nonvolatile memory area is, for example, a ROM. The volatile memory area is, for example, a RAM.

The auxiliary storage device 13 corresponds to an auxiliary storage part of the above computer. For example, an EEPROM, HDD, or SSD can be the auxiliary storage device 13. The auxiliary storage device 13 stores data used when the processor 11 performs various processing, data created by the processing in the processor 11, and the like. The auxiliary storage device 13 may store application programs including a control program to be described later.

The communication interface 14 is connected to the network 80. The communication interface 14 performs data communication with another device connected via the network 80 according to a communication protocol under the control of the processor 11.

The real store server 10 having such a configuration uses a part of the volatile memory area of the main memory 12 as an area of a shopping basket memory 121 to be created. The real store server 10 can create a plurality of shopping basket memories 121 in this area.

FIG. 5 is a schematic diagram showing an example of the shopping basket memory 121. As shown in FIG. 5, the shopping basket memory 121 has an area for storing a user ID, one to a plurality of ordered commodity data, one to a plurality of purchased commodity data, a total discount amount, a total amount, and an accounting barcode. The ordered commodity data is data registered in the order file 31 when a purchaser who visits a real store operates the user terminal 3 in advance to access a virtual store and orders commodities.

The purchased commodity data includes commodity identification code, commodity name, price, quantity, sales amount, tax amount, and the like of the purchased commodity purchased by the purchaser at the real store. The total discount amount is the total of the discount amounts generated in transactions with the purchaser. The total amount is an amount obtained by subtracting the total discount amount from the sum of the sales amount and the tax amount included in the purchased commodity data. The accounting barcode is a barcode of a unique accounting code generated for each transaction in order to identify a transaction with the purchaser.

The real store server 10 stores a collective discount table 131 in the auxiliary storage device 13.

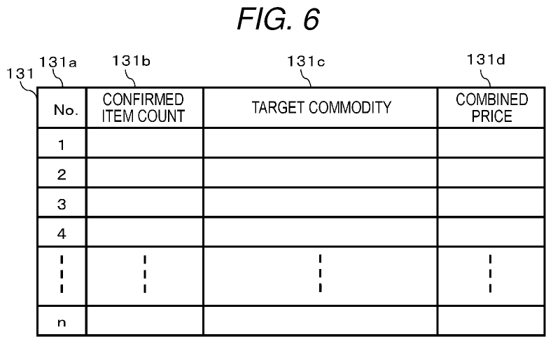

FIG. 6 is a schematic diagram showing the data structure of the collective discount table 131. As shown in FIG. 6, the collective discount table 131 includes a number area 131a, a confirmed item count area 131b, a target commodity area 131c, and a combined price area 131d. In the number area 131a, table numbers that continue from “1” in ascending order are described. In the confirmed item count area 131b, the number of items of commodities for which a collective discount is confirmed is recorded. In the target commodity area 131c, the identification code of the commodity that is the target of the collective discount is recorded as many as the number of available items. In the combined price area 131b, the price when the collective discount is confirmed is recorded.

For example, if the conclusion condition of the collective discount is “200 Yen when purchasing two items of commodity A and commodity B together”, in the collective discount table 131, “2” is recorded in the confirmed item count area 131b in association with one table number, the identification codes of the commodities A and B are recorded in the target commodity area 131c, and “200” is recorded in the combined price area 131d.

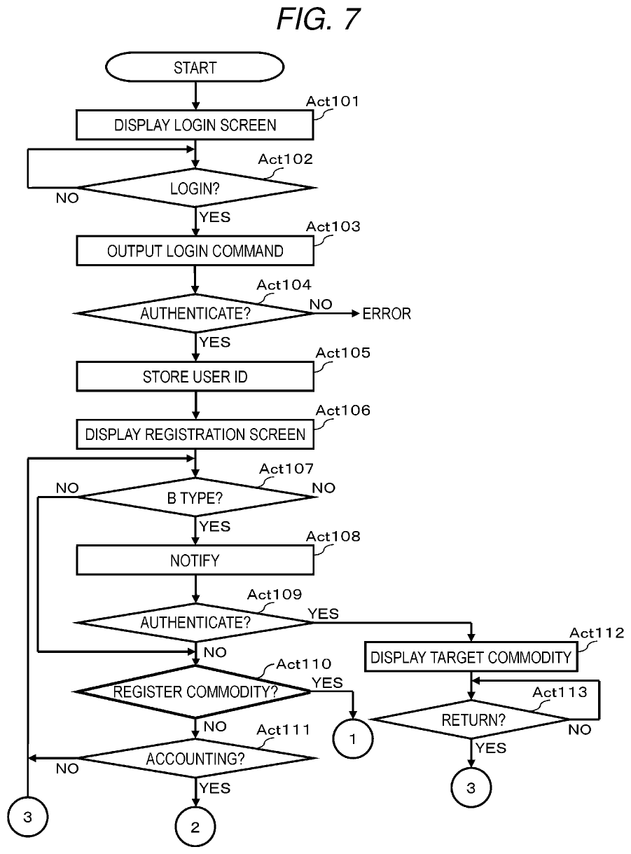

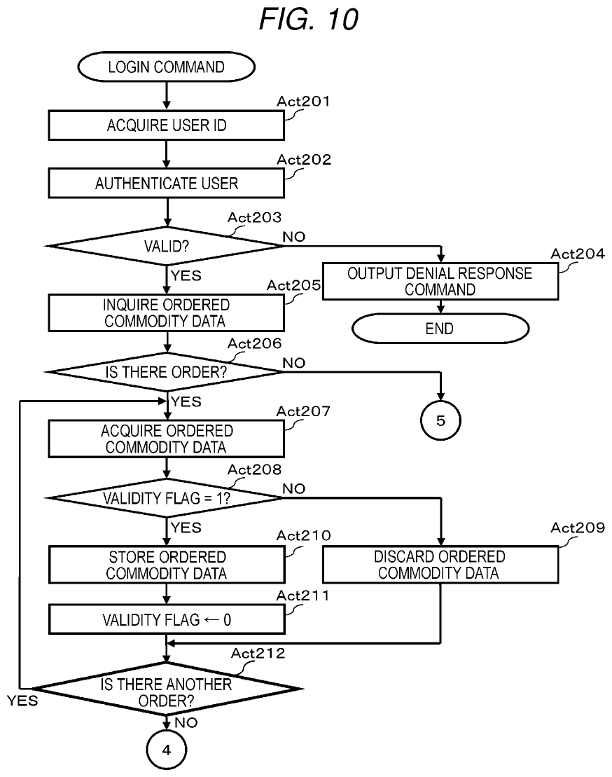

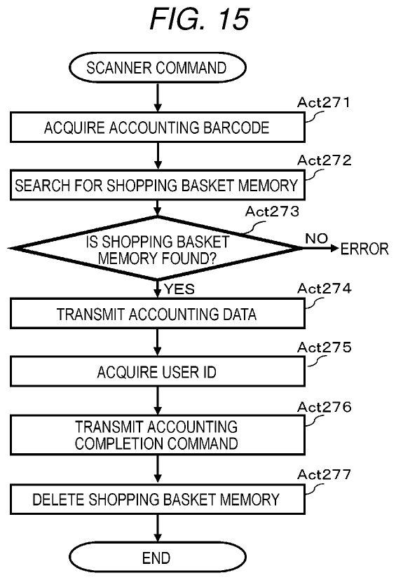

FIGS. 7 to 9 are flowcharts showing main information processing procedures executed by the processor 61 of the information terminal 60 according to the terminal program. FIGS. 10 to 14 are flowcharts showing the procedures of information processing executed by the processor 11 of the real store server 10 in response to reception of main commands transmitted from the information terminal 60. This procedure follows the control program. FIG. 15 is a flowchart showing an information processing procedure executed by the processor 11 of the real store server 10 in response to the reception of a scanner command transmitted from the accounting machine 50. This procedure also follows the control program.

Hereinafter, the main operation of the sales system 1 will be described with reference to these flowcharts. Specifically, this is the operation from when the purchaser who has ordered the first commodity at the virtual store and purchases the second commodity related to the ordered first commodity at the real store registers the purchased second commodity by using the information terminal 60 of the cart C and performs accounting with the accounting machine 50. The content of the operation described below is an example. The procedure is not particularly limited as long as similar results can be obtained.

<Operation Related to Login>

A purchaser who has visited a real store takes out a cart C from a cart storage area and touches the touch panel 65 of the information terminal 60 provided in the cart C. In the information terminal 60, when the touch panel 65 is touched, the processor 61 in an idle state is activated. Then, the processor 61 starts information processing of the procedure shown in the flowchart of FIG. 7.

First, the processor 61 displays a login screen on the touch panel 65 as Act101. The login screen is a screen for accepting a login operation. For example, a purchaser has a recording medium on which a user ID is recorded. The recording medium is the user terminal 3 such as a smartphone. The recording medium may be a card medium such as an IC card or a magnetic card. When the recording medium is the user terminal 3, the user ID is displayed on the display device of the user terminal 3 in the form of a barcode or a two-dimensional data code by the action of the application program installed in the user terminal 3. The purchaser confirming the login screen causes the scanner 66 to read the user ID displayed on the display device of the user terminal 3. When the user ID is read by the scanner 66, the user ID is given to the processor 61 at the information terminal 60. When the recording medium is a card medium, the purchaser causes the reader 67 to read data on the card medium. When the data on the card medium is read by the reader 67, the user ID included in the data is given to the processor 61.

The processor 61 that has displayed the login screen is waiting for a login operation as Act 102. Upon confirming that the login operation has been performed, the processor 61 determines YES in Act 102 and proceeds to Act 103. The processor 61 controls the wireless unit 64 to output a login command as Act 103 to the real store server 10. By this control, the wireless unit 64 wirelessly transmits the login command. The login command is received by the access point 70 and sent to the real store server 10 via the network 80. The login command includes the user ID input by the login operation.

When the processor 11 of the real store server 10 receives a command from the information terminal 60 via the communication interface 14, the processor 11 checks the type of the command. If the received command is a login command, the processor 11 starts login command reception processing of the procedure shown in the flowchart of FIG. 10.

The processor 11 acquires the user ID from the login command as Act 201. Then, the processor 11 authenticates the user identified by the user ID as Act 202. Specifically, the processor 11 inquires of the database server 40 whether or not a member record including the user ID exists in the member database 43. As a result, when receiving a response from the database server 40 that the corresponding member record exists in the member database 43, the processor 11 determines that the user authentication is valid. When receiving a response from the database server 40 that the corresponding member record does not exist in the member database 43, the processor 11 determines that the user authentication is invalid.

The processor 11 that has performed the user authentication confirms the authentication result as Act 203. If the authentication result is invalid, the processor 11 determines NO in Act 203 and proceeds to Act 204. The processor 11 controls the communication interface 14 to output a denial response command with the information terminal 60 that is the login command transmission source as a destination as Act 204. With this control, the communication interface 14 transmits a denial response command to the network 80. The denial response command is wirelessly transmitted from the access point 70 via the network 80 and received by the information terminal 60 that is the transmission source of the login command.

Thus, the processor 11 ends the login command reception processing when the user authentication is invalid.

If the authentication result is valid, the processor 11 determines YES in Act 203 and proceeds to Act 205. The processor 11 inquires of the order server 30 about the presence or absence of ordered commodity data 311P including the user ID acquired from the login command as Act 205. Hereinafter, the ordered commodity data 311 including the user ID acquired from the login command is represented as order commodity data 311P.

In response to this inquiry, the order server 30 searches the order file 31 to determine whether or not there is the ordered commodity data 311P for which the inquiry has been made. Then, the determination result is notified from the order server 30 to the real store server 10.

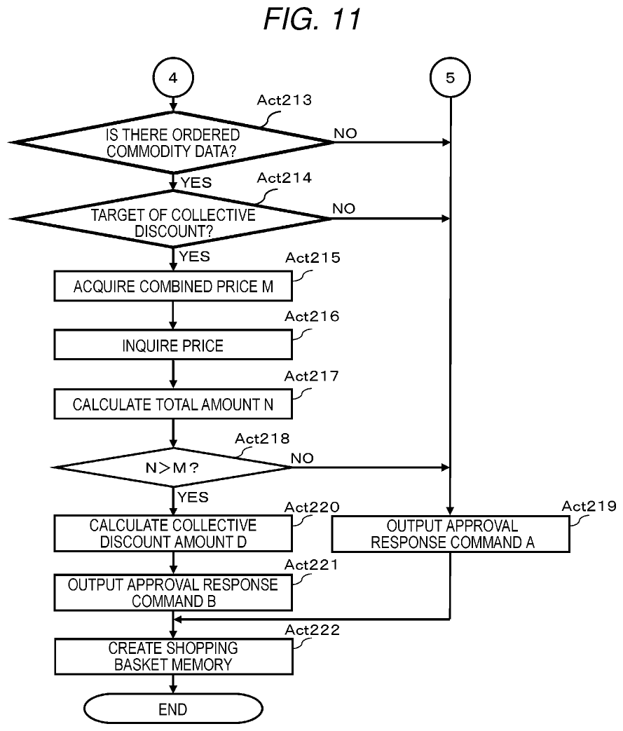

The processor 11 of the real store server 10 that has made an inquiry to the order server 30 waits for a determination result from the order server 30 as Act 206. As a result, when the response indicating that the ordered commodity data 311P does not exist is received, the processor 11 determines NO in Act 206 and proceeds to Act 219 in FIG. 11. The processing of Act 219 will be described later.

If the response indicating that the ordered commodity data 311P exists is received, the processor 11 determines YES in Act 206 and proceeds to Act 207. The processor 11 acquires one of the ordered commodity data 311P from the order server 30 as Act207. Then, the processor 11 checks the validity flag of the ordered commodity data 311P as Act208. When the validity flag is reset to “0”, the ordered commodity data 311P is invalid. In this case, the processor 11 determines NO in Act 208 and proceeds to Act 209. The processor 11 discards the ordered commodity data 311P as Act209.

If the validity flag of the ordered commodity data 311P is set to “1”, the processor 11 determines YES in Act 208 and proceeds to Act 210. The processor 11 stores the ordered commodity data 311P as Act 210 in the temporary storage buffer of the main memory 12. Further, the processor 11 notifies the order server 30 to change the validity flag of the ordered commodity data 311P to “0” as Act211. Upon receiving this notification, the order server 30 changes the validity flag of the ordered commodity data 311P stored in the order file 31 from “1” to “0”.

When the processing of Act 209 or Act 211 is completed, the processor 11 confirms whether there is any other ordered commodity data 311P corresponding to the order file 31 as Act 212. If other ordered commodity data 311P exists, the processor 11 determines YES in Act 212 and returns to Act 207. Then, the processor 11 acquires new ordered commodity data 311P and executes the processing of Act208 to Act211 described above again.

In this way, when there are a plurality of pieces of ordered commodity data 311P in the order file 31, Act 208 to Act 211 are executed for all the ordered commodity data 311P. Then, when it is confirmed that unprocessed data does not exist in the order file 31 in the ordered commodity data 311P, the processor 11 determines NO in Act 212 and proceeds to Act 213 in FIG. 11.

The processor 11 confirms whether or not the ordered commodity data 311P is stored in the temporary storage buffer of the main memory 12 as Act213. In the temporary storage buffer, the ordered commodity data 311P is stored in the processing of Act 210 described above. That is, of the ordered commodity data 311P related to the commodity that the purchaser who has logged in to the information terminal 60 previously ordered at the virtual store, the ordered commodity data 311P of which validity flag is set to “1” is temporarily stored in the storage buffer. Hereinafter, the ordered commodity data 311P stored in the temporary storage buffer is represented as ordered commodity data 311Q. The number of ordered commodity data 311Q is not necessarily one. A plurality of pieces of ordered commodity data 311Q may be stored in the temporary storage buffer.

When no ordered commodity data 311P is stored in the temporary storage buffer, that is, when the ordered commodity data 311Q does not exist, the processor 11 determines NO in Act 213 and proceeds to Act 219 described later.

When at least one piece of ordered commodity data 311P is stored in the temporary storage buffer, that is, when the ordered commodity data 311Q exists, the processor 11 determines YES in Act 213 and proceeds to Act 214. The processor 11 confirms whether or not the ordered commodity data of the first commodity that is the target of the collective discount is included in the ordered commodity data 311Q as Act 214.

Specifically, the processor 11 searches the collective discount table 131 for the ordered commodity code included in the ordered commodity data 311Q for each piece of ordered commodity data 311Q. Then, the processor 11 confirms the presence or absence of the ordered commodity data 311Q of which ordered commodity code is recorded in the target commodity area 131c. Hereinafter, the ordered commodity data 311Q of which ordered commodity code is recorded in the target commodity area 131c is represented as ordered commodity data 311R. The ordered commodity data 311R is the ordered commodity data 311Q of the first commodity that is the target of the collective discount. When the ordered commodity data 311R does not exist, the processor 11 determines NO in Act 214 and proceeds to Act 219 described later.

If there is at least one piece of ordered commodity data 311R, the processor 11 determines YES in Act 214 and proceeds to Act 215. The processor 11 acquires a combined price M from the combined price area 131d corresponding to the target commodity area 131c in which the ordered commodity code included in the ordered commodity data 311R is recorded for each piece of ordered commodity data 311R as Act 215. In addition, the processor 11 inquires of the database server 40 about the price of the commodity identified by another commodity identification code recorded in the target commodity area 131c along with the ordered commodity code, that is, the second commodity that is the target of the collective discount due to the relevance with the first commodity as Act 216.

In response to this inquiry, the database server 40 searches the commodity database 41 and reads the price recorded in the commodity record including the commodity identification code for which the inquiry has been made. Then, this price data is sent from the database server 40 to the real store server 10.

When the price data is acquired from the database server 40, the processor 11 of the real store server 10 calculates a total amount N of the first commodity and the second commodity to be discounted together as Act 217. The total amount N is an amount obtained by adding the order price of the first commodity included in the ordered commodity data 311R to the selling price at the real store of the second commodity obtained from the price data acquired from the database server 40.

When the calculation of the total amount N is completed, the processor 11 confirms whether or not the total amount N larger than the combined price M is calculated as Act 218. If the first commodity is discounted when the first commodity is ordered at the virtual store, there may be a case where the total amount N of the order price of the first commodity and the selling price of the second commodity is equal to or less than the combined price M. When the total amount N is equal to or lower than the combined price M, the purchaser cannot receive the collective discount service even if he or she purchases the commodity as a collective discount target. In this case, the processor 11 determines NO in Act 218 and proceeds to Act 219.

As described above, when it is determined NO in Act 206 of FIG. 10 or NO is determined in Act 213, Act 214, or Act 218 of FIG. 11, the processor 11 proceeds to Act 219. The processor 11 controls the communication interface 14 to output an A-type approval response command with the information terminal 60 that is the transmission source of the login command as a destination as Act 219. By this control, the communication interface 14 transmits an A-type approval response command to the network 80. The A type approval response command includes the user ID acquired from the login command. The A-type approval response command is wirelessly transmitted from the access point 70 via the network 80 and received by the information terminal 60 that is the transmission source of the login command.

In Act 217, when the total amount N is larger than the combined price M, the purchaser can receive the collective discount service by purchasing the second commodity as a collective discount target. In this case, the processor 11 determines YES in Act 218 and proceeds to Act 220. The processor 11 calculates a collective discount amount D as Act220. The collective discount amount D is an amount obtained by subtracting the combined price M from the total amount N.

When the collective discount amount D is calculated, the processor 11 controls the communication interface 14 to output a B-type approval response command with the information terminal 60 that is the transmission source of the login command as the destination as the Act 221. With this control, the communication interface 14 transmits a B-type approval response command to the network 80. The B-type approval response command includes the user ID obtained from the login command, the ordered commodity data 311R of which total amount N is greater than the combined price M, the data related to the second commodity as the collective discount, and data of collective discount amount D. The B-type approval response command is wirelessly transmitted from the access point 70 via the network 80 and received by the information terminal 60 that is the transmission source of the login command.

If the processor 11 controls the output of the A-type or B-type approval response command, the processor 11 creates the shopping basket memory 121 in a predetermined area of the main memory 12 as Act 222. Then, the processor 11 records the user ID acquired from the login command in the shopping basket memory 121. Further, when the ordered commodity data 311R is included in the ordered commodity data 311Q stored in the temporary storage buffer, the processor 11 records the ordered commodity data 311R in the shopping basket memory 121. Thereafter, the processor 11 deletes the ordered commodity data 311Q from the temporary storage buffer.

Thus, the processor 11 ends the login command reception processing when the user authentication is valid.

Description will be made by referring back to FIG. 7.

The processor 61 of the information terminal 60 that has controlled the output of the login command in Act 103 waits for a response command from the real store server 10 as Act 104. When the denial response command is received from the real store server 10, the processor 61 determines NO in Act 104 and sets the login as an error.

When the login fails, the purchaser who is the operator of the information terminal 60 performs an error cancellation operation from the touch panel 65. When the cancellation operation is performed, the processor 61 resumes the processing from Act1. Therefore, the purchaser logs in again. [0075]In Act 104, if the processor 61 receives an A-type or B-type approval response command from the real store server 10, the processor 61 determines YES and proceeds to Act 105. The processor 61 stores the user ID included in the approval response command in the main memory 62 as Act 105. Further, the processor 61 displays a registration screen on the touch panel 65 as Act 106. The registration screen is a screen for displaying a list of purchased commodities such as commodity names, quantity, prices of commodities purchased by the purchaser, and the total amount.

The processor 61 identifies whether the approval response command is the A-type or the B-type as Act 107. If it is a B-type approval response command, the processor 61 determines YES in Act 107 and proceeds to Act 108. Based on the ordered commodity data 311R and the collective discount amount D data included in the approval response command as Act 108, the processor 61 performs a notification operation for notifying the purchaser that a collective discount service is available. The notification operation is performed by using the registration screen.

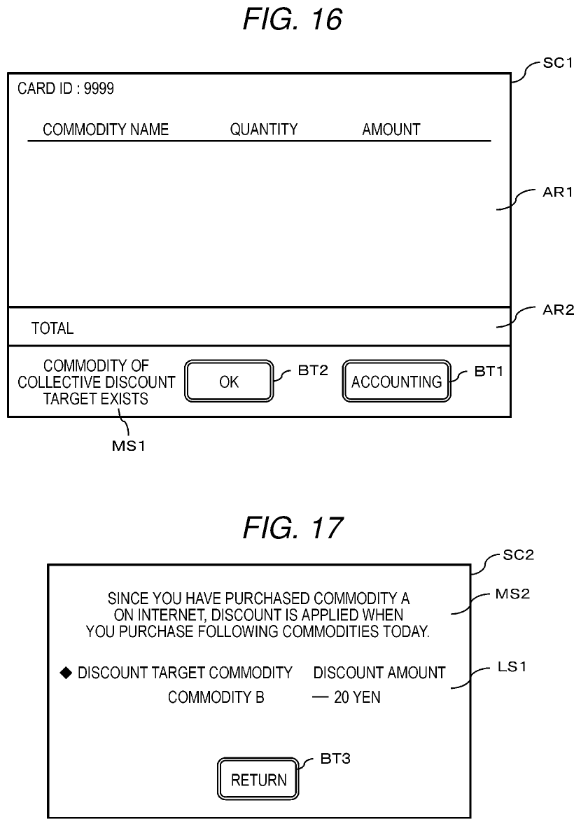

FIG. 16 is an example of a registration screen SC1 on which a notification operation is performed. As shown in the drawing, the registration screen SC1 includes a display area AR1 for a list of purchased commodities and a total display area AR2. In addition, an image of the accounting button BT1 is displayed on a part of the registration screen SC1. The accounting button BT1 is input when the purchaser instructs accounting.

In addition, the image of a message MS1 and an OK button BT2 is displayed on part of the registration screen SC1 by the notification operation of Act108. The message MS1 is a content for notifying the purchaser that a collective discount service is available. The OK button BT2 is input when the purchaser instructs confirmation of service contents.

The content of the message MS1 is not particularly limited. In the present embodiment, it is the content which notifies that the commodities as collective discounts are sold in the store. Therefore, the purchaser who has confirmed the message MS1 inputs the OK button BT2 when he or she wants to know the items of the commodity as a collective discount.

When the processing of Act 108 is completed, the processor 61 proceeds to Act 109. The processor 61 confirms whether or not the OK button BT2 is input as Act109. When the OK button BT2 is not input, the processor 61 determines NO in Act 109 and proceeds to Act 110. The processor 61 confirms whether or not commodity registration has been performed as Act 110. If the commodity registration has not been performed, the processor 61 determines NO in Act 110 and proceeds to Act 111. The processor 61 confirms whether or not the accounting button BT1 is input as Act111. If the accounting button BT1 has not been input, the processor 61 determines NO in Act 111 and returns to Act 107. Here, when the processor 61 receives the B-type approval response command, the processor 61 waits for the OK BT2 to be input, for the commodity registration to be performed, or for the accounting button BT1 to be input in the processing of Act109 to Act111.

In this standby state, when the OK button BT2 is input, the processor 61 determines YES in Act 109 and proceeds to Act 112. The processor 61 displays a detail screen of the collective discount service on the touch panel 65 as Act112. The detail screen is a screen for notifying the purchaser of information on commodities for which a collective discount is applicable in combination with commodities ordered at a virtual store.

FIG. 17 is an example of a detail screen SC2. As shown in the drawing, the detail screen SC2 displays a message MS2, a list LS1 of the commodity name and collective discount amount of the second commodity as a collective discount target, and an image of a return button BT3. The message MS2 is a content for notifying that there is a second commodity for which a collective discount is available due to the relevance with the first commodity (commodity A) ordered at the virtual store. The list LS1 indicates that a collective discount is available because the purchaser has purchased the commodity B as the second commodity related to the first commodity in the real store and a discount of 20 yen is applied. The return button BT3 is input when the purchaser completes confirming the detail screen SC2.

After displaying the detail screen SC2, the processor 61 waits for an input operation of the return button BT3 as Act113. When the return button BT3 is input, the processor 61 returns to Act 107. That is, the processor 61 returns to the standby state of Act109 to Act111 described above.

On the other hand, when the A-type approval response command is received, the processor 61 determines NO in Act 107, skips the processing of Act 108 and Act 109, and proceeds to Act 110. That is, the processor 61 waits for commodity registration as Act 110 or input of the accounting button BT1 as Act 111.

<Operation Related to Registration of Purchased Commodities>

The purchaser who has confirmed that the registration screen SC1 is displayed on the touch panel 65 of the information terminal 60 goes to the sales floor and stores the commodities to be purchased, so-called purchased commodities, in the cart C. At this time, the purchaser causes the scanner 66 to read the code symbol attached to the purchased commodity before putting the purchased commodity into the cart C. When the code symbol is read by the scanner 66, the commodity identification code represented by the code symbol is input to the information terminal 60. That is, the commodity identified by the commodity identification code is registered.

Some commodities, such as fresh food, may not have a code symbol. When the code symbol is not attached to the purchased commodity, the purchaser touches the commodity button corresponding to the purchased commodity from the commodity buttons displayed on the touch panel 65. When the commodity button is touched, the commodity identification code of the commodity corresponding to the commodity button is input to the information terminal 60. That is, the commodity identified by the commodity identification code is registered.

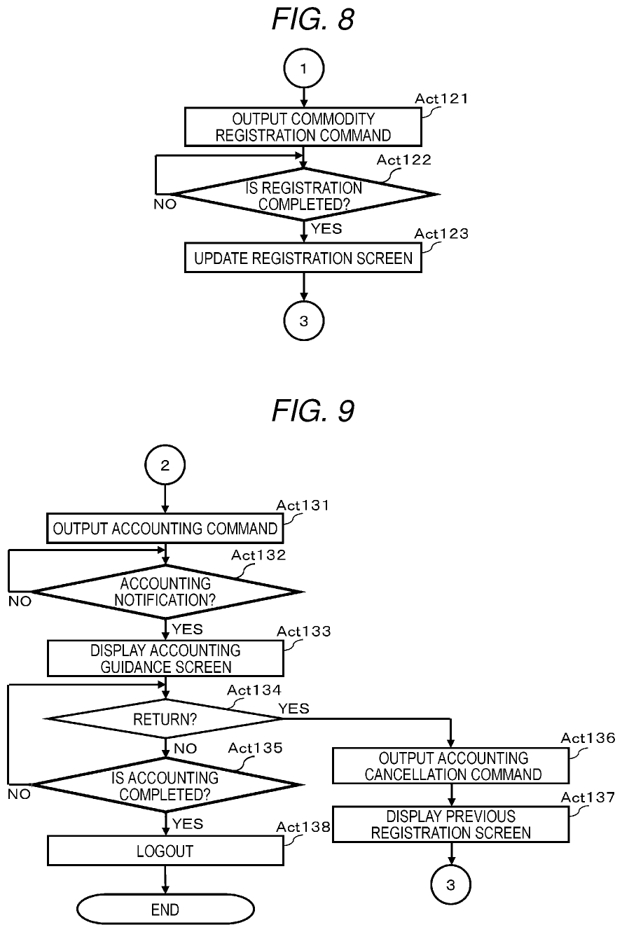

When the processor 61 of the information terminal 60 in the standby state of Act 109 to Act 111 or in the standby state of Act 110 and Act 111 confirms that the commodity registration has been performed, the processor 61 determines YES in Act 110 and proceeds to Act 121 in FIG. 8. The processor 61 controls the wireless unit 64 to output a commodity registration command to the real store server 10 as Act 121. By this control, the wireless unit 64 wirelessly transmits a commodity registration command. The commodity registration command includes the user ID stored in the processing of Act 105 and the commodity identification code of the registered commodity. The commodity registration command is received by the access point 70 and sent to the real store server 10 via the network 80.

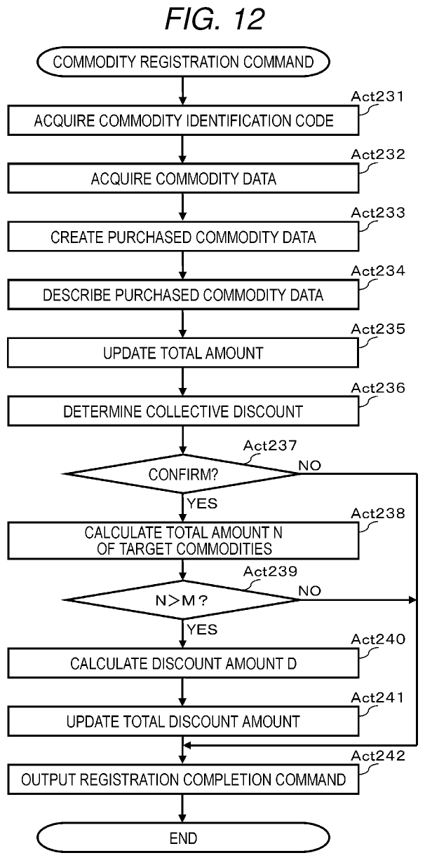

When the processor 11 of the real store server 10 confirms that the command received via the communication interface 14 is a commodity registration command, the processor 11 starts command reception processing according to the procedure shown in the flowchart of FIG. 12.

The processor 11 acquires a commodity identification code from the commodity registration command as Act231. Then, the processor 11 inquires of the database server 40 about the commodity data of the commodity identified by the commodity identification code as Act232. In response to this inquiry, the database server 40 searches the commodity database 41 and reads commodity data such as price and commodity name recorded in the commodity record including the commodity identification code. The commodity data is sent from the database server 40 to the real store server 10. The processor 11 of the real store server 10 stores the commodity data sent from the database server 40 in the temporary storage memory.

The processor 11 generates purchased commodity data based on the commodity data stored in the temporary storage memory as Act233. Then, the processor 11 records the purchased commodity data in the shopping basket memory 121 including the user ID acquired from the commodity registration command as Act 234. Further, the processor 11 updates the total amount of the shopping basket memory 121 to an amount obtained by adding the price of the purchased commodity data as Act 235. The purchased commodity data includes the commodity identification code of the purchased commodity, the selling price at the real store, the commodity name, and the like. [0091]The processor 11 determines whether or not a collective discount is available as Act236. Specifically, the processor searches the collective discount table 131 with data obtained by combining the ordered commodity code of the ordered commodity data stored in the shopping basket memory 121 and the commodity identification code of the purchased commodity data recorded in the shopping basket memory 121 by the processing of Act234. Then, the processor 11 confirms whether or not data matching the combination data exists in the target commodity area 131c. If data matching the combination data does not exist, the collective discount is not available. If data matching the combination data exists, the collective discount is available.

The processor 11 determines whether or not a collective discount is available as Act237. If the collective discount is not available, the processor 11 determines NO in Act 237 and proceeds to Act 242. The processing of Act 242 will be described later.

When the collective discount is available, the processor 11 determines YES in Act 237 and proceeds to Act 238. The processor 11 calculates the total amount N of the commodities as a collective discount target as Act238. That is, the processor 11 calculates the total amount N by adding the order price of ordered commodity data for which an ordered commodity code exists in the target commodity area 131c and the selling price of purchased commodity data for which a commodity identification code exists in the target commodity area 131c.

If the total amount N is calculated, the processor 11 confirms whether the total amount N is larger than the collective discount amount D of the combined price area 131d corresponding to the target commodity area 131c as Act 239. If the total amount N is equal to or less than the collective discount amount D, the processor 11 determines NO in Act 239 and proceeds to Act 242. The processing of Act 242 will be described later.

When the total amount N is larger than the collective discount amount D, the processor 11 determines YES in Act 239 and proceeds to Act 240. The processor 11 calculates the discount amount D by subtracting the combined price M from the total amount N as Act240. Then, the processor 11 adds the discount amount D to the total discount amount of the shopping basket memory 121 as Act 241. Further, the processor 11 subtracts the discount amount D from the total amount of the shopping basket memory 121. Thereafter, the processor 11 proceeds to Act242.

Thus, when it is determined as NO in Act 237 or Act 239, or when the processing of Act 241 is completed, the processor 11 proceeds to Act 242. The processor 11 controls the communication interface 14 to output a registration completion command with the information terminal 60 that is the transmission source of the commodity registration command as a destination as Act 242. With this control, the communication interface 14 transmits the registration completion command to the network 80. The registration completion command includes a purchased commodity list, a total discount amount, and a total amount. The purchased commodity list is generated from the purchased commodity data stored in the shopping basket memory 121 including the user ID acquired from the commodity registration command. The registration completion command is wirelessly transmitted from the access point 70 via the network 80 and received by the information terminal 60 that is the transmission source of the commodity registration command. Thus, the processor 11 ends the commodity registration command reception processing.

Description will be made by referring back to FIG. 8.

The processor 61 of the information terminal 60 that has controlled the output of the commodity registration command in Act 121 waits for a registration completion command as Act 122. When the registration completion command is received from the real store server 10, the processor 61 determines YES in Act 122 and proceeds to Act 123. The processor 61 updates the registration screen SC1 displayed on the touch panel 65 as Act123. That is, the processor 61 updates the purchased commodity list included in the registration completion command so as to be displayed in an area Al of the registration screen SC1. Further, the processor 61 updates the total amount and the total discount amount included in the registration completion command so as to be displayed in an area A2 of the registration screen SC1.

Thereafter, the processor 61 returns to Act 107 in FIG. 7. Then, the processor 61 enters the standby state of Act 109 to Act 111 or the standby state of Act 110 and Act 111.

<Operation Related to Registration Completion of Purchased Commodities>

The purchaser who has finished shopping inputs the accounting button BT1 from the registration screen SC1 displayed on the touch panel 65 of the information terminal 60 in order to perform accounting.

When the processor 61 of the information terminal 60 in the standby state of Act109 to Act111 or in the standby state of Act110 and Act111 detects that the accounting button BT1 has been input, the processor 61 determines YES in Act111 and proceeds to Act131 of FIG.9. The processor 61 controls the wireless unit 64 to output an accounting command to the real store server 10 as Act 131. With this control, the wireless unit 64 wirelessly transmits an accounting command. The accounting command is received by the access point 70 and sent to the real store server 10 via the network 80. The accounting command includes the user ID stored in the processing of Act 105.

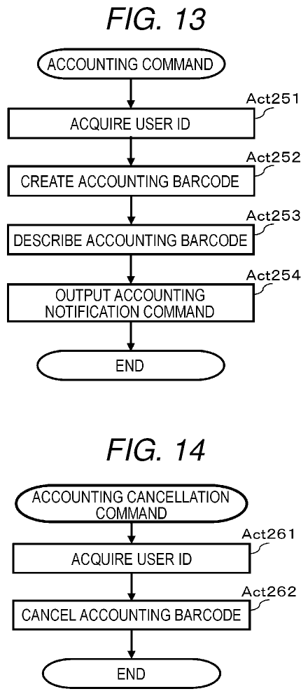

When the processor 11 of the real store server 10 confirms that the command received via the communication interface 14 is an accounting command, the processor 11 starts command reception processing according to the procedure shown in the flowchart of FIG. 13.

The processor 11 acquires the user ID from the accounting command as Act 251. The processor 11 also generates an accounting barcode as Act252. Then, the processor 11 records the accounting barcode in the shopping basket memory 121 in which the user ID acquired in the processing of Act 251 is set as Act 253.

The processor 11 controls the communication interface 14 to output an accounting notification command with the information terminal 60 that is the transmission source of the accounting command as a destination as Act 245. With this control, the communication interface 14 transmits the accounting notification command to the network 80. The accounting notification command includes the total amount of the shopping basket memory 121 in which the user ID acquired from the accounting command is recorded and the accounting barcode. The accounting notification command is wirelessly transmitted from the access point 70 via the network 80 and received by the information terminal 60 that is the transmission source of the accounting command. Thus, the processor 11 ends the accounting command reception processing.

Description will be made by referring back to FIG. 9.

The processor 61 that has controlled the transmission of the accounting command waits for an accounting notification command as Act 132. Upon receipt of the accounting notification command, the processor 61 determines YES in Act 132 and proceeds to Act 133. The processor 61 sets the screen of the touch panel 65 in an accounting guidance screen as Act 133.

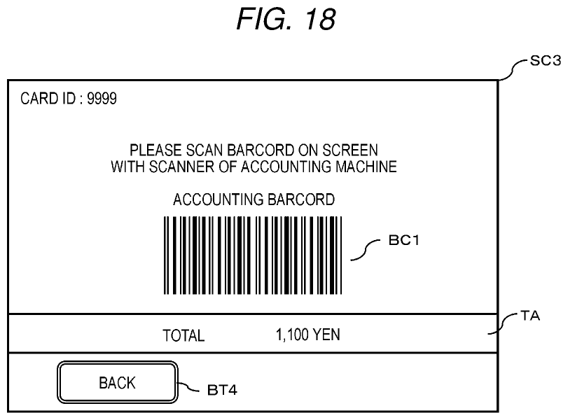

An example of an accounting guidance screen SC3 is shown in FIG. 18. As shown in FIG. 18, an accounting barcode BC1 and a total amount TA included in the accounting notification command are displayed on the accounting guidance screen SC3. In addition, an image of a [Back] button BT4 is also displayed. The [Back] button BT4 is input when the purchaser instructs to cancel accounting.

The processor 61 displaying the accounting guidance screen SC3 confirms whether or not the [Back] button BT4 is input as Act134. If the [Back] button BT4 is not input, the processor 61 determines NO in Act 134 and proceeds to Act 135. The processor 61 confirms whether or not an accounting completion command has been received as Act135. The accounting completion command will be described later. If the accounting completion command has not been received, the processor 61 determines NO in Act 135 and returns to Act 134. Here, the processor 61 waits for the [Back] button BT4 to be input or to receive the accounting completion command in Act134 and Act135.

In this standby state, when it is detected that the [Back] button BT4 is input, the processor 61 determines YES in Act134 and proceeds to Act136. The processor 61 controls the wireless unit 64 to output an accounting cancellation command to the real store server 10 as Act136. With this control, the wireless unit 64 wirelessly transmits an accounting cancellation command. The accounting cancellation command is received by the access point 70 and sent to the real store server 10 via the network 80. The accounting cancellation command includes the user ID acquired in the processing of Act105.

The processor 61 that has controlled the transmission of the accounting cancellation command returns the screen of the touch panel 65 to the registration screen SC1 immediately before switching to the accounting guidance screen SC3 as Act 137. Thereafter, the processor 61 returns to Act 107 in FIG. 7. Then, the processor 61 enters the standby state of Act 109 to Act 111 or the standby state of Act 110 and Act 111.

When the processor 11 of the real store server 10 confirms that the command received via the communication interface 14 is an accounting cancellation command, the processor 11 starts command reception processing according to the procedure shown in the flowchart of FIG. 14.

The processor 11 acquires the user ID from the accounting cancellation command as Act 261. Then, the processor 11 deletes the accounting barcode from the shopping basket memory 121 including the user ID as Act 262. Thus, the processor 11 ends the processing for receiving the accounting cancellation command.

<Operation Related to Accounting for Purchased Commodities>

The purchaser who has finished shopping goes to the place where the accounting machine 50 is installed together with the cart C. Then, the purchaser causes the scanner of the accounting machine 50 to read the accounting barcode BC1 of the accounting guidance screen SC3 displayed on the touch panel 65 of the information terminal 60. Then, the scanner command is transmitted from the accounting machine 50 to the real store server 10. The scanner command includes accounting barcode data.

The processor 11 of the real store server 10 that has received the scanner command starts processing of the procedure shown in the flowchart of FIG. 15. In other words, the processor 11 acquires accounting barcode data from the scanner command as Act 271. Then, the processor 11 searches the area where the shopping basket memory 121 of the main memory 12 is created with the data of the accounting barcode as Act 272.

The processor 11 determines whether or not there is a shopping basket memory 121P in which the data of the accounting barcode is recorded as Act273. Hereinafter, the shopping basket memory 121 in which the data of the accounting barcode acquired from the scanner command is recorded is referred to as a shopping basket memory 121P.

If the shopping basket memory 121P does not exist, the processor 11 determines NO in Act 273 and determines that an input of the scanner command is an error. When the input of the scanner command results in an error, the accounting machine 50 notifies the error. The purchaser who has confirmed the error will scan the accounting barcode again.

If the shopping basket memory 121P exists, the processor 11 determines YES in Act 273 and proceeds to Act 274. The processor 11 controls the communication interface 14 so as to output the purchased commodity data recorded in the shopping basket memory 121P, the total discount amount, and the total amount data as accounting data necessary for settlement processing to the accounting machine 50 that is the transmission source of the scanner command as Act 274. With this control, the communication interface 14 transmits the accounting data to the network 80. The accounting data is sent to the accounting machine 50 that is the transmission source of the scanner command, and settlement processing is executed. Since the settlement processing is well-known processing in the accounting machine 50, a description thereof is omitted here.

The processor 11 that has controlled the transmission of the accounting data obtains the user ID recorded in the shopping basket memory 121P as Act275. The processor 11 controls the communication interface 14 to output an accounting completion command with the information terminal 60 that is the transmission source of the accounting command as a destination as Act 276. With this control, the communication interface 14 transmits the accounting completion command to the network 80. The accounting completion command includes the user ID acquired from the shopping basket memory 121P. The accounting completion command is wirelessly transmitted from the access point 70 via the network 80 and received by the information terminal 60 that is the transmission source of the accounting command. The processor 11 deletes the shopping basket memory 121P as Act277. Thus, the processor 11 ends the scanner command reception processing.

Description will be made by referring back to FIG. 9.

When the processor 61 in the standby state for Act 134 and Act 135 receives the accounting completion command, the processor 61 determines YES in Act 135 and proceeds to Act 138. The processor 61 logs out as Act138. When the logout is completed, the processor 61 ends the information processing according to the terminal program.

This is the end of the description of the main operation of the sales system 1.

As is clear from the above description, the real store server 10 includes an identification unit that identifies a purchaser who has visited a store, a first acquisition unit that acquires ordered commodity data as order information on the commodity ordered by the purchaser through the virtual store, a second acquisition unit that acquires purchased commodity data as purchase information on the commodity purchased by the purchaser at the real store, and a provision unit that provides a service when a condition of a collective discount service is satisfied from the ordered commodity data obtained by the first acquisition unit and the purchased commodity data obtained by the second acquisition unit.

That is, the computer having the processor 11 of the real store server 10 as a main body implements the identification unit by executing the processing of Act 201 to Act 203 in FIG. 10 according to the control program. The computer implements the first acquisition unit by executing the processing of Act205 to Act212 of FIG. 10 according to the control program. The computer implements the second acquisition unit by executing the processing of Act231 to Act234 in FIG. 12 according to the control program. The computer implements the provision unit by executing the processing of Act 236 to Act 241 in FIG. 12 according to the control program.

In the sales system 1 provided with the real store server 10 having such a configuration, it is possible to provide a purchaser with a so-called collective discount service that sells a second commodity related to a first commodity ordered at a virtual store at a discount when the second commodity is purchased at a real store.

Further, the real store server 10 includes a search unit that searches a commodity that satisfies the condition of the service from the order information acquired by the first acquisition unit, and a notification unit that notifies information on the commodity detected by the search unit.

That is, the computer having the processor 11 of the real store server 10 as a main body implements the identification unit by executing the processing of Act 205 to Act 214 in FIG. 10 according to the control program. The computer implements the notification unit by executing the processing of Acts 215 to Act 221 of FIG. 10.

In the sales system 1 provided with the real store server 10 having such a configuration, when the second commodity related to the first commodity ordered at the virtual store is purchased at the real store, the purchaser can be notified that a discount service is available for him or her. In addition, the purchaser can be notified of what the second commodity is and how much the discount amount is. Therefore, the purchaser who has visited the real store is able to know in advance information on which commodities are available to receive a discount service.

Moreover, the notification unit notifies the information terminal 60 used by the purchaser when shopping at the real store. Therefore, in the real store where the purchaser operates the information terminal 60 attached to the cart C to register the purchased commodity, there is no need to prepare a terminal for receiving the notification separately from the information terminal 60, and the existing system can be used effectively.

Further, the real store server 10 includes a determination unit that determines whether to provide a service based on the price of the commodity when the purchaser orders the commodity through the virtual store, and the provision unit provides the service when the condition of the service is satisfied and it is determined by the determination unit that the service is to be provided.

That is, the computer having the processor 11 of the real store server 10 as a main body implements the determination unit by executing the processing of Act 215 to Act 218 in FIG. 11 according to the control program.

In the sales system provided with the real store server 10 having such a configuration, the collective discount service will be implemented only when the sum of the order price of the first commodity ordered and the selling price of the second commodity at the real store purchased at the real store is greater than the combined price of the first commodity and the second commodity. In other words, when the total price of the order price when the first commodity is ordered and the selling price when the second commodity is purchased at the real store is equal to or less than the combined price of the first commodity and the second commodity, the collective discount service is not implemented. Therefore, there is no possibility that a collective discount service that is disadvantageous to the purchaser will be implemented.

As described above, the embodiment of the commodity data processing device that can provide a service to a purchaser based on the relationship between the commodity ordered at a virtual store and the commodity purchased at a real store has been described, but such an embodiment is not limited thereto.

In the above-described embodiment, the case where a collective discount service is provided to a purchaser has been described, but the type of service is not limited to the collective discount service. For example, when a second commodity related to a first commodity ordered at a virtual store is purchased at a real store, services such as issuing a coupon or increasing the rate of bonus points may be provided to a purchaser.

Moreover, in the embodiment, the case where a service can be provided to a purchaser based on the relevance of the commodity ordered in a virtual store and the commodity purchased in a real store is exemplified. In this regard, when a commodity related to a commodity purchased at a real store is ordered at a virtual store, a service may be provided to a purchaser.

In the above-described embodiment, a case is shown in which a purchaser orders a commodity through a virtual store published on a website, but the method for ordering a commodity is not limited thereto. For example, a purchaser may place an order for a commodity by inputting order information into a data file with a predetermined input format and sending an e-mail attached with the data file to a predetermined e-mail address. Alternatively, the purchaser may place an order for a commodity by using a message application such as [LINE] (registered trademark) or [WhatsApp] (registered trademark).

The storage location of the collective discount table 131 may not be the real store server 10. For example, the order server 30 or the database server 40 may be used. [0131]The condition for offering the collective discount may not be a commodity unit. For example, a collective discount may be available when a commodity belonging to the first commodity category and a commodity belonging to the second commodity category are purchased. In this case, in the target commodity area 131c of the collective discount table 131, a code for identifying the first commodity category and a code for identifying the second commodity category are recorded. A first commodity classification and a second commodity classification maybe common. In other words, when a commodity belonging to the same commodity classification is purchased for the number of items, a collective discount maybe available.

In the embodiment, the case where a purchaser himself or herself operates the information terminal 60 provided in the cart C to register the commodities purchased by the purchaser in the real store is exemplified. In this regard, a store clerk or a purchaser may register purchased commodities by operating a known POS terminal provided in a real store. That is, the real store server 10 acquires information on the purchased commodities registered through the POS terminal as the second acquisition unit, and a service may be provided when a condition of the service is satisfied from the information and the order information acquired by the first acquisition unit.

In the embodiment, the case where the control program is stored in the main memory 12 or the auxiliary storage device 13 in advance for the real store server 10 is exemplified. In this regard, the commodity data processing device may be configured in a state where the control program is not stored in the main memory 12 or the auxiliary storage device 13. In that case, a control program assigned separately from the commodity data processing device may be written in a writable storage device provided in the commodity data processing device, in response to an operation by a user or the like. The control program can be transferred by recording the control program on a removable recording medium or by communication via a network. The recording medium may be in any form as long as the medium can store a program such as a CD-ROM or a memory card and can be read by the device.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity data processing device, comprising:
an identification component for identifying a purchaser who visits a store;
a first acquisition component for acquiring order information on a first commodity ordered by the purchaser previously at an internet site of the store;
a second acquisition component for acquiring purchase information on a second commodity purchased by the purchaser at the store; and
a provision component for providing a price discount to the second commodity when a conclusion condition is satisfied from the order information acquired by the first acquisition component and the purchase information acquired by the second acquisition component.

2. The device according to claim 1, further comprising:
a search component for searching for a commodity satisfying the condition from the order information acquired by the first acquisition component; and
a notification component for notifying information relating to the commodity detected by the search component.

3. The device according to claim 2, wherein
the notification component notifies an information terminal used by the purchaser in the store.

4. The device according to claim 1, further comprising:
a determination component for determining whether or not to provide a service based on a price of the first commodity when the purchaser orders the first commodity, wherein
the provision component provides the service when the condition of the service is satisfied and the determination component determines to provide the service.

5. The device according to claim 1, wherein
the service comprises a collective discount service that offers a discount when a combination of a first commodity and a second commodity is established.

6. The device according to claim 1, wherein
the first acquisition component and the second acquisition component are connected via a network.

7. A control method of causing a computer to perform the following functions:
identifying a purchaser who visits a store,
acquiring order information on a first commodity ordered by the purchaser previously at an internet site of the store,
acquiring purchase information on a second commodity purchased by the purchaser in the store, and
providing a price discount to the second commodity when a condition is satisfied from the order information acquired and the purchase information acquired.

8. The method according to claim 7, further comprising:
searching for a commodity satisfying the condition from the order information acquired; and
notifying information relating to the commodity detected by searching.

9. The method according to claim 8, further comprising:
notifying an information terminal used by the purchaser in the store.

10. The method according to claim 7, further comprising:
determining whether or not to provide a service based on a price of the first commodity when the purchaser orders the first commodity; and
providing the service when the condition of the service is satisfied and determining to provide the service.

11. The method according to claim 7, further comprising:
offering a collective discount service including a discount when a combination of a first commodity and a second commodity is established.

12. The method according to claim 7, further comprising:
performing settlement processing.

13. The method according to claim 7, further comprising:
detecting online registration prior to acquiring order information.

14. A commodity data processing system, comprising:
an identification component for identifying a purchaser who visits a physical store;
a virtual store server comprising a first acquisition component for acquiring order information on a first commodity ordered by the purchaser previously at an internet site of the physical store;
a real store server comprising a second acquisition component for acquiring purchase information on a second commodity purchased by the purchaser at the physical store;
a provision component for providing a price discount to the second commodity when a conclusion condition is satisfied from the order information acquired by the first acquisition component and the purchase information acquired by the second acquisition component; and
a network connecting the virtual store server and the real store server.

15. The system according to claim 14, further comprising:
a search component for searching for a first commodity satisfying the condition from the order information acquired by the first acquisition component; and
a notification component for notifying information relating to the first commodity detected by the search component.

16. The system according to claim 15, wherein
the notification component notifies an information terminal used by the purchaser in the store.

17. The system according to claim 14, further comprising:
a determination component for determining whether or not to provide a service based on a price of the first commodity when the purchaser orders the first commodity, wherein
the provision component provides the service when the condition of the service is satisfied and the determination component determines to provide the service.

18. The system according to claim 17, wherein
the service comprises a collective discount service that offers a discount when a combination of a first commodity and a second commodity is established.

19. The system according to claim 14, wherein
a settlement processing component.

20. The system according to claim 14, wherein
the network connecting the virtual store server and the real store server is a wired network or a wireless network.
